(19) United States
(12) Patent Application Publication
(10) Pub. No.: US 2015/0304913 A1
(43) Pub. Date: Oct. 22, 2015

(54) SYSTEM AND METHOD FOR PROACTIVE U-PLANE HANDOVERS

(71) Applicant: Nokia Technologies OY, Espoo (FI)

(72) Inventors: Mikko Uusitalo, Helsinki (FI); Zexian Li, Espoo (FI)

(73) Assignee: Nokia Technologies OY, Espoo (FI)

(21) Appl. No.: 14/411,341

(22) PCT Filed: Jul. 17, 2012
(86) PCT No.: PCT/IB2012/053647

§ 371 Date: May 25, 2015

(51) Int. Cl. H04W 36/04; H04W 36/02; H04W 4/02; H04W 36/00

(52) U.S. Cl. CPC H04W 36/04; H04W 36/0055; H04W 36/02; H04W 4/02

(57) ABSTRACT

A user equipment UE has a c-plane connection to a macro cell and a u-plane connection to a source local cell. The u-plane connection is handed over to a target local cell while maintaining the c-plane connection so the macro cell can facilitate the u-plane handover. In one embodiment the UE uses coverage information about the source local cell and its own mobility to predict when the handover is needed, and the macro cell can identify which is the target local cell. The handover can occur across a coverage gap between the source and target local cells, where the UE gets synchronization information and a dedicated preamble for the target local cell prior to being in its range. In the examples also path switching and transfer of the UE context can occur prior to the UE being in range of the target local cell.

### TECHNICAL FIELD

This invention relates generally to wireless communication, and more specifically relates to handovers of user equipments from one access node to another, particularly in a heterogeneous network with macro and micro/pico cells.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

Release 10 of the evolved universal terrestrial radio access network (E-UTRAN, also known as long term evolution or LTE) operates with carrier aggregation (CA), in which the whole system bandwidth is divided into multiple component carriers (CCs). FIG. 1 illustrates the general concept of the LTE carrier aggregation concept. At least one of the component carriers, designated as the primary component carrier (PCC, sometimes referred to as the PCell), is backwards compatible with legacy Release 8. For a Release 10 compatible user equipment (UE) capable of operating on multiple CCs, the network will assign to it one PCC and may additionally assign to it one or more secondary CCs (SCCs, sometimes referred to as SCells).

LTE-Advanced (LTE-A) is directed toward providing higher data rates at very low cost. One significant change is that LTE-A is to include bandwidth extensions beyond 20 MHz, for example aggregations of larger or smaller CCs than 20 MHz. Some studies predict that wireless traffic volume will increase by a factor of 1000 between 2010 and 2020. As the possibilities of CA have been explored and developed to better handle this burgeoning traffic volume the concept of heterogeneous network have evolved, in which smaller (local) cells operating on one or more SCC bands lie within a larger cell operating on the PCC band and possibly also one or more SCC bands. In the LTE terminology the access node of the larger cell is termed a macro eNB and the access nodes of the smaller/local cells are variously termed micro (or pico) eNBs, home eNBs (HeNBs), or access points (APs). This same terminology is used herein in a generic manner and does not necessarily imply only the LTE or LTE-A radio access technology.

Due to the heavily increasing wireless traffic and difficulty of further expanding the amount of macro cells, particularly in large cities where the distance between macro cells are quite short already, there is an increasing need to move traffic to those local cells. FIG. 2 depicts an example heterogeneous network with one macro cell connected to three pico/local cells over X2 data/control interfaces. Within the geographic coverage area of the macro cell/macro eNB 22 there can be many local small cells/APs 23, 24, 25. Such local small cells can be operating on licensed or unlicensed frequency bands. The right-most SCC of FIG. 1 is frequency non-contiguous with the other CCs to indicate it lies in the unlicensed spectrum.

Offloading traffic to unlicensed bands, or more technically to license-exempt bands, is one way to manage the increasing wireless traffic load and the Third Generation Partnership Project (3GPP) has been exploring details of how to make that happen efficiently. See for example document RP-111354 by Intel entitled NEW STUDY ITEM PROPOSAL FOR RADIO LEVEL DYNAMIC FLOW SWITCHING BETWEEN 3GPP-LTE AND WLAN ((3GPP TSG RAN#53; Fukuoma, Japan; 13-16 Sep. 2011) which explores how unlicensed spectrum could benefit cellular via integrated use of wireless local area network (WLAN) with cellular. WLAN does have small cells which can lie inside a particular LTE macro cell, but WLAN bring transmit power and thus range limitations. Similarly, if LTE would use the unlicensed band those LTE small cells would also be local due to power limitations on the unlicensed band itself. Other usage scenarios have the offloading to the licensed band, where for example the operator can allocate some of its own radio spectrum to one or more local cells or the small cells can operate over dedicated spectrum for local deployment.

Another paper relevant to the problem of unlicensed band small cells within a licensed band macro cell is by Lenin Ravindranath, Hari Balakrishnan and Samuel Madden entitled IMPROVING WIRELESS NETWORK PERFORMANCE USING SENSOR HINTS (http://nms.csail.mit.edu/papers/wesp-nsdi11-final.pdf, last visited Jun. 27, 2012; referenced by MIT NEWS; CONSTANT CONNECTION dated Apr. 12, 2011, see http://web.mit.edu/newsoffice/2011/motion-data-wireless-0412.html). This paper details a protocol for either maximizing throughput or minimizing handovers, and utilizes relative signal strength and heading information of a mobile client to update the period for scanning neighbor APs (to maximizing throughput) and to update a list of AP signal strengths to find a preferred one for handing over (to minimize handovers).

And finally there is a detailed presentation by NTT DoCoMo which characterizes enhancements for both wide area (macro) coverage and local area coverage that are proposed to improve spectrum efficiency for future advancements of the LTE radio access technology (see REQUIREMENTS, CANDIDATE SOLUTIONS & TECHNOLOGY ROADMAP FOR LTE REL-12 ONWARD by NTT DoCoMo, Inc.; 3GPP Workshop on Release 12 and onwards; Ljubljana, Slovenia; 11-12 Jun. 2012).

### BRIEF DESCRIPTION OF THE DRAWINGS

FIG. 1 is a schematic diagram showing component carriers in a carrier aggregation system such as might be used in a heterogeneous network.

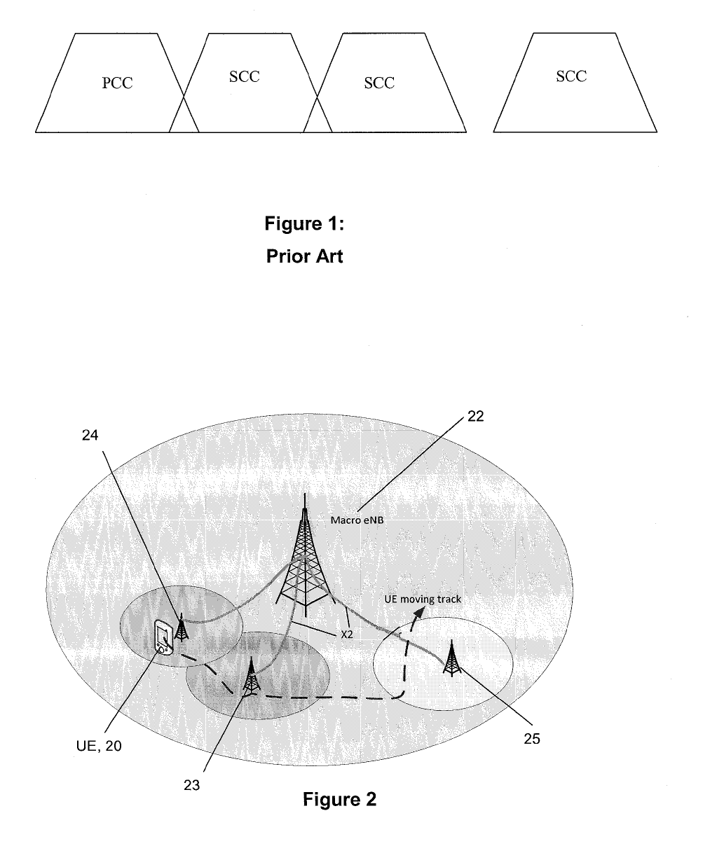

FIG. 2 is a schematic diagram of a heterogeneous network radio environment in which embodiments of these teachings may be practiced to advantage.

FIG. 3 is a signaling diagram showing an example handover procedure between LTE APs within one LTE macro eNB as shown in FIG. 2, and is one non-limiting implementation of these teachings.

FIGS. 4-6 are logic flow diagrams that illustrates from the perspective of a user equipment, of a source local cell, and of a macro cell respectively, the operation of a method, and a result of execution by an apparatus of a set of computer program instructions embodied on a computer readable memory, in accordance with the exemplary embodiments of this invention.

FIG. 7 is a simplified block diagram of a user equipment and a source local cell/AP and a macro cell/eNB, all of which are exemplary devices suitable for use in practicing the exemplary embodiments of the invention.

### SUMMARY

In a first exemplary aspect of the invention there is a method which includes: while a user equipment is connected to a macro cell at least in a control-plane; a) establishing a user-plane connection to a source local cell; b) predicting when a user-plane handover from the source local cell will be needed; and c) utilizing the macro cell to facilitate the user-plane handover of the user equipment from the source local cell to a target local cell.

In a second exemplary aspect of the invention there is an apparatus which includes at least one processor and at least one memory including computer program code. The at least one memory and the computer program code are configured, with the at least one processor and in response to execution of the computer program code, to cause the apparatus to at least: while a user equipment comprising the apparatus is connected to a macro cell at least in a control-plane: a) establish a user-plane connection to a source local cell; b) predict when a user-plane handover from the source local cell will be needed; and c) utilize the macro cell to facilitate the user-plane handover of the user equipment from the source local cell to a target local cell.

In a third exemplary aspect of the invention there is a computer readable memory storing a program of instructions comprising: code for establishing a user-plane connection to a source local cell; code for predicting when a user-plane handover from the source local cell will be needed; and code for utilizing the macro cell to facilitate the user-plane handover of the user equipment from the source local cell to a target local cell.

In a fourth exemplary aspect of the invention there is a method which includes: at a source local cell, establishing with a user equipment a user-plane connection; the source local cell providing to the user equipment information about a coverage area of the source local cell; and handing over the user-plane connection of the user equipment to a target local cell according to a handover prediction based on location and mobility of the user equipment.

In a fifth exemplary aspect of the invention there is an apparatus which includes at least one processor and at least one memory including computer program code. The at least one memory and the computer program code are configured, with the at least one processor and in response to execution of the computer program code, to cause the apparatus to at least: establish with a user equipment a user-plane connection; provide to the user equipment information about a coverage area of the source local cell; and handover the user-plane connection of the user equipment to a target local cell according to a handover prediction based on location and mobility of the user equipment.

In a sixth exemplary aspect of the invention there is a computer readable memory storing a program of instructions comprising: code for establishing with a user equipment a user-plane connection; code for providing to the user equipment information about a coverage area of the source local cell; and code for handing over the user-plane connection of the user equipment to a target local cell according to a handover prediction based on location and mobility of the user equipment.

In a seventh exemplary aspect of the invention there is a method which includes: a macro cell establishing a control-plane connection with a user equipment; the macro cell offloading traffic to and/or from the user equipment to a source local cell while maintaining the control-plane connection; and the macro cell facilitating a user-plane handover of the user equipment from the source local cell to a target local cell.

In an eighth exemplary aspect of the invention there is an apparatus which includes at least one processor and at least one memory including computer program code. The at least one memory and the computer program code are configured, with the at least one processor and in response to execution of the computer program code, to cause the apparatus to at least: establish a control-plane connection with a user equipment; offload traffic to and/or from the user equipment to a source local cell while maintaining the control-plane connection; and facilitate a user-plane handover of the user equipment from the source local cell to a target local cell.

In a ninth exemplary aspect of the invention there is a computer readable memory storing a program of instructions comprising: code for establishing a control-plane connection with a user equipment; code for offloading traffic to and/or from the user equipment to a source local cell while maintaining the control-plane connection; and code for facilitating a user-plane handover of the user equipment from the source local cell to a target local cell.

### DETAILED DESCRIPTION

The teachings below describe a handover of a UE 20 from a source AP to a target AP. There are several salient distinctions of the handover according to these teachings as compared to prior art handovers. Appreciating these differences in advance will make the following more detailed examples more clear.

Firstly, in these teachings the UE 20 maintains its connection with the macro cell, at least in the control plane (c-plane), and the handover is between the local cells and only in the user plane (u-plane). Contrast this with the prior art in which even a soft handover is typically total, both c-plane and u-plane are transferred to the target cell.

Secondly, the u-plane handover between the two local cells is facilitated by the macro cell. Contrast this with the prior art where typically the only network access nodes involved in a handover are the source or serving node and the target node. While some prior art handovers might utilize some node higher in the cellular network hierarchy such as a mobility management entity MME to aid in transferring handover-related information from a serving eNB to a drift eNB, such higher nodes are not access nodes, and are not in radio contact with the UE directly but only through the access nodes.

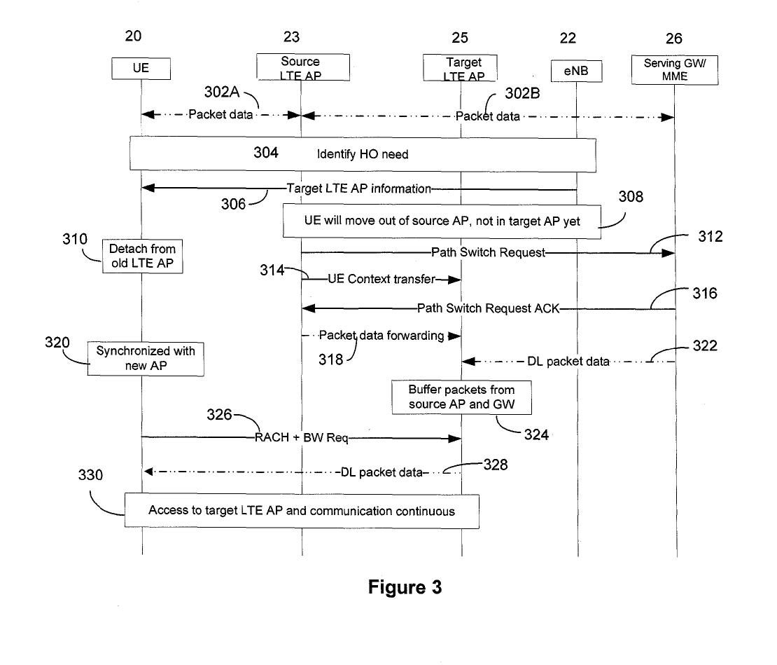

Thirdly, these teachings enable a direct u-plane handover between two local cells even if there is a coverage gap between them, such as is shown between AP 23 and AP 25 at FIG. 2. In the prior art such a handover across a coverage gap is typically not allowed, and even if one were intentionally attempted the result would be a lost connection and dropped uplink (UL) and/or downlink (DL) data if there were some active data exchange ongoing during a handover across such a coverage gap. Prior art handovers generally are limited to the UE handing over between cells with overlapping coverage areas, such as between AP 24 and AP 23 in FIG. 2, so the UE's wireless connection will not be lost.

From the first distinction above it is clear the UE will maintain a constant connection with the macro cell 22. In a carrier aggregation arrangement this will be on the PCC (and thus on the licensed band) and the advantageous deployment scenario is that the macro cell is utilizing additional capacity from local cells each with a SCC. In one particularly advantageous embodiment these local cells are utilizing the unlicensed band, but the examples below can be easily extended to the case where the local cells operate in licensed radio spectrum. The UE 20 is therefore connected with the macro cell 22 at least in the c-plane throughout the handover process described below. It may be that the UE 20 also has some u-plane connection with the macro cell 22 also but for simplicity the examples below all u-plane activity for the subject UE 20 is with the local cells. This is for clarity in describing these teachings rather than by way of limiting their scope.

As an overview of a handover between local cells according to these teachings, mobility/location information of the UE 20 is used to predict the need for handover between the local cells and then that handover, if actually needed, is facilitated in a proactive way. The UE 20 first obtains information about the geographic coverage area of the small cell to which it is connected, which enables it to recognize from its own position and mobility any potential need for a handover. This general concept of facilitating handovers between local cells within a macro cell based on location and coverage information is also not seen within the prior art, as is the concept of handing over between local cells while remaining anchored to the macro cell.

While the examples below assume the local cells involved in the u-plane handover are under the same macro cell, these examples are readily extended to two further cases. One, where the source local cell is under a source macro cell and the target local cell is under an adjacent target macro cell. For this case there is a u-plane handover between the two local cells which is fully consistent with the examples below, and additionally a c-plane handover between the two adjacent macro cells. The examples below are simply extended for this case such that the two macro cells exchange the necessary information which the examples below assume are held only in the single macro cell. The second extension of the below teachings concerns a handover among macro cells only. In the case of applying the same method between macro cells, information on source and target macro cell coverage would be needed at the source macro cell, i.e., information would exist at all macro cells concerning themselves and their neighbors. Then the handovers could be done in a similar proactive way with the macro cells carrying over the actions described here both for local and the macro cells. One difference is that in this case both c- and u-plane would be handed over.

In the specific examples below the handover is assumed to be between local cells with a coverage gap between them since that is the more complex case. Without loss of generality these examples assume the LTE radio access technology, so the macro cell which maintains the c-plane coverage for the UE 20 throughout will be the macro eNB 22 of FIG. 2, and the u-plane handover will be from the source LTE AP 23 to the target LTE AP 25 as shown generally at FIG. 2.

Exemplary embodiments of these teachings have the UE 20 obtaining information on the coverage area of the connectivity of its source AP 23. For example, this might be in the form of a polygon (xᵢ, yᵢ) which give Cartesian coordinates (or polar or some other coordinate system). In another embodiment this coverage area may be in the form of a geographic location of the source AP 23 and an estimate of its coverage radius. If the source AP 23 is operating on multiple frequencies the polygon may be of the format (xᵢ, yᵢ, fᵢ), where fᵢ indicates the center frequency of the i^{th} band relevant to the indicated coverage area. A similar frequency-specific coverage area may be given using the location and coverage radius format. In one embodiment the UE 20 obtains this coverage information when first establishing a connection with the source AP 23. Alternatively the UE 20 may obtain this coverage information from the source AP's broadcast system information SI. In a still further example the UE 20 can obtain coverage information of the various local cells from the macro cell 22, via dedicated signaling which would carry only coverage information of those local cells that are relevant to the UE's current position, or via broadcast system information (such as in the master information block) which can carry coverage information for all local cells under that macro eNB 22 (and possibly also all local cells that are under an adjacent macro cell and that are also adjacent to one of the local cells that is under that broadcasting macro eNB's coverage area).

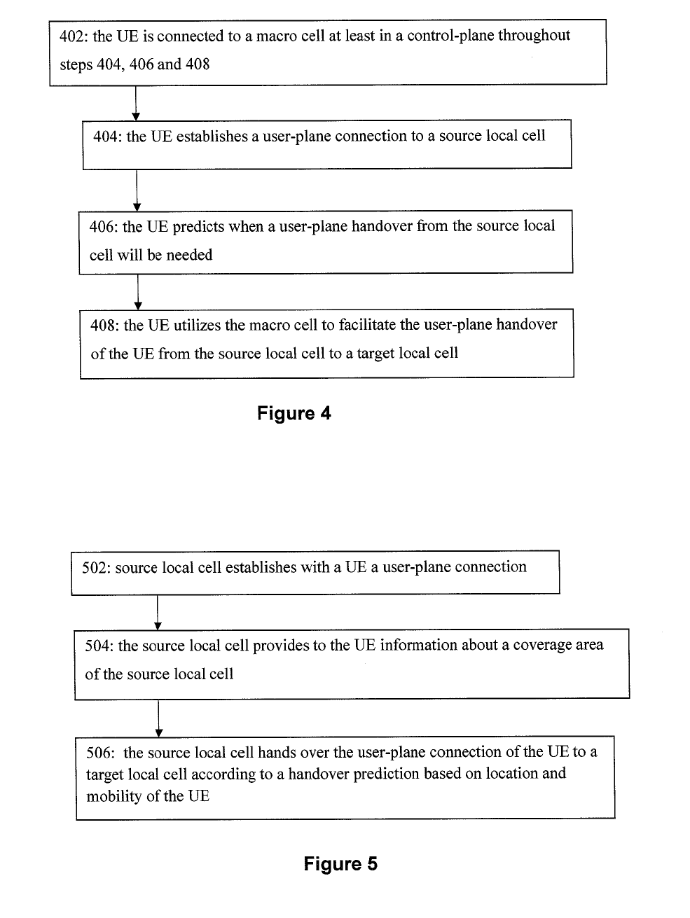

FIG. 3 begins with the UE 20 established with the source AP 23 and exchanging packet data 302A with it, which is also exchanged 302B between the source AP 23 and the serving gateway (GW/MME) 26 and the wider Internet. As noted above the UE 20 also knows the coverage area of the source AP 23, and the UE 20 will then detect whether or not it is moving. The UE 20 can in an embodiment obtain the coverage information about the local AP 23 over its u-plane connection with the macro eNB 22. The macro cell 22 can learn the coverage information of the various local cells 23, 24, 25 from those cells directly, over its X2 (or other data/control) interface with them as is shown at FIG. 2. The UE 20 can do detect whether and what direction it is moving by using its own internal accelerometers, or from location information that the UE 20 obtains via a satellite positioning system (GPS or GLANOSS for example) or by triangulating from terrestrial radio transmitters whose location is known. If the UE 20 detects that it is moving, it then runs a software routine to check whether there will soon be a need for a handover at 304 of FIG. 3. The UE 20 can then use the information on its location, its movement track (which is obtained by successive locations) and its speed to predict if and when the UE would go out of the coverage area of its source AP 23. If this time to the edge of the coverage area is less than some predetermined threshold then the UE 20 deems that a handover is likely and prepares as follows.

The UE 20 can then consult with the network, preferably the macro eNB 22 but alternatively the source AP 23, to determine which is the likely next target AP. There are several ways to implement this; for example the UE 20 can inform the network at 304 of FIG. 3 of its predicted time and position when it will reach the edge of the source AP's coverage area. In a preferred embodiment this exchange is with the macro eNB 22 in order that the macro eNB 22 can check whether there are sufficient radio resources available in the target AP, or the macro eNB 22 may already know that the target AP is unable to take any additional traffic load. If there are no suitable candidate target APs (and typically there will be only one candidate target AP since it is assumed they have relatively small coverage areas compared to the macro cell) the macro eNB 22 can simply move the UE's u-plane back to the macro eNB 22 itself, and at the same time disable any UE measurement of the unsuitable target AP(s) that the UE 20 might be collecting for handover purposes.

If the UE's movement continues towards the target AP 25 and there are available radio resources in it, then there are two options depending on whether the target cell has overlapping coverage area with the source AP 23. If the expected target AP is adjacent to the source AP 23 (such as AP 24 in FIG. 2 if the UE 20 were moving from source AP 23 towards target AP 24), a facilitated handover would be established if the UE's measurements of that target AP's 24 signal strength would support the handover. In this case the UE's neighbor cell measurements can have less strict thresholds than is traditional since there is additional information (UE location and mobility information for example) available to trust that a handover is really needed. If instead the expected target AP is not adjacent (such as AP 25 in FIG. 2 if the UE 20 were moving from source AP 23 in the direction of the arrow towards AP 25), and the signal strength of the source AP 23 is diminishing, the source AP 23 would be used as long as possible and then a facilitated handover to the next non-adjacent target AP 25 would be initiated. This is the scenario relevant to the example signaling diagram of FIG. 3; the UE at 308 moves out of coverage of the source AP 23 but is not yet in coverage with the target AP 25. When coming closer to the intended target AP 25, the UE's signal measurements concerning that AP 25 would be initiated.

In an example embodiment, that facilitated handover would entail the macro eNB 22 informing the UE 20 at 306 of FIG. 3 about information of the target AP 25, such as for example the identity of the target AP 25 and its synchronization information. In this facilitated handover there is also proactive data path switching, in which the data path can be set up before the UE moves to the target AP 25. For example, the source AP 23 can send a path switch request 312 to the serving GW/MME 26 directly or via the macro eNB 22 once the UE 20 moves out of coverage 308 and detaches 310, and then securely transfer the UE's context 314 including security keys, bearer quality of service (QoS) profiles and the like, to the target AP 25. Once the source AP 23 receives in return a path switch acknowledgement (ACK) 316 it can begin forwarding 318 any data it has buffered from or for the UE 20 to the target AP 25. In this manner, right after the UE 20 is in the new target AP 25, DL data can be delivered to the UE 20 without any additional delays.

Having the synchronization data and the target AP 25 information the UE 20 received at 306, it can then synchronize 320 to the target AP 25 even before it is in range. To make the UE's re-entry to the target AP 25 even easier for the case of a coverage gap considering that the target AP 25 is in this example operating in the unlicensed band, the target AP information 306 may also include a dedicated preamble which the UE 20 can use on the target AP's random access channel (RACH) for establishing itself to that AP 25.

During the time the UE 20 is in the coverage gap, it will of course have no access node to send any UL data it has (assuming it has only a c-plane connection with the macro eNB 22) and so will hold its own UL data. During that u-plane coverage gap DL data for the UE 20 can be buffered in the serving GW/MME 26, and sent to the target AP 25 at 322 of FIG. 3 even before the UE 20 is established with it in which case the target AP 25 also buffers at 324 of FIG. 3 the packets from the MME 26 as well as those from the source AP 23. This can significantly reduce control signaling between the macro eNB 22, the UE 20 and the source and target APs 23, 25 as compared to more conventional handover buffering techniques. Additionally this will reduce the load in the macro eNB 22, and while there is a bit of extra latency that is inherent in effecting a u-plane handover across a coverage gap. The macro eNB 22 can take on the u-plane function to avoid this latency but at the cost of much more signaling and so the minor latency issue is seen to more than compensate for the control signaling savings.

Finally the UE 20 establishes itself with the target AP 25, such as via a RACH procedure 326 where the UE 20 requests some bandwidth (BW) allocation. Once established the target AP 25 will send all the buffered DL data it has for this UE 20 at 328. After that the UE 20 and the target AP 25 engage in normal communications 330 and the handover is completed.

For the case in which the u-plane handover is between local APs with overlapping coverage areas such as AP 23 and AP 24 of FIG. 2, it is possible to achieve a diversity gain during the handover process. Specifically, in an embodiment of these teachings in that scenario the same DL packets can be delivered by the source AP 23 and the target AP 24. The UL packets however would preferably be sent by the UE 20 to only the (single) local AP to which its u-plane was currently attached.

The signaling diagram of FIG. 3 is only exemplary and not limiting to the broader teachings herein. For example, in one variation of the above description of FIG. 3 the UE 20 can learn which local APs are adjacent to the one to which the UE 20 has its u-plane attached. This might be communicated to the UE 20 by the source AP as a list with the locations or vector directions of those neighbor local APs relative to the UE's source AP, for example sent to the UE 20 when it first attached its u-plane or alternatively broadcast by the source AP. Whatever the form this can be considered as a local cell deployment ‘map’, and in an alternative embodiment the macro cell 22 can provide this information to the UE 20 such as when the u-plane is attached to the macro cell 22 prior to the macro cell 22 offloading the UE 20 to the unlicensed band local cell; or the macro cell 22 can provide this information over the c-plane when receiving the UE's location and mobility information (304 of FIG. 3); or the macro eNB 22 can broadcast this map information for the whole macro cell. In any of these alternative embodiments then there would be no need for the UE 20 to specifically request the neighbor local cell information from the macro eNB 22 when it is expecting a handover, and in these embodiments the UE 20 may not need to send its location and mobility information uplink which is an additional savings in control overhead signaling. In these embodiments handovers could also be done if the signal strength that the UE 20 measures from its current source AP 23 is lower than a threshold and the UE's own location would fit with connectivity to the next local AP as the UE 20 determines itself from the deployment map information it received.

In an embodiment the local APs also report information to the macro eNB 22 about each handover in which they participate. From this information collected over time the macro eNB 22 can learn the actual handover conditions (for example, how many packets were dropped and needed re-transmission from a handover switch that occurred to early or late for a given UE speed) and make adjustments to improve further handovers. For example, the macro eNB 22 can adjust the coverage area information for any of the local APs to change the UE's determination of when exactly a local handover might be necessary. Such coverage area adjustments may arise from changing channel conditions, due for example to interference, traffic load, and/or environmental conditions.

From the above examples it is clear that certain embodiments of these teachings provide several technical effects, including enabling an efficient usage of the local cell capacity, a lower packet loss rate on average, and better service continuity with less latency. This leads to fewer Radio Link timeouts and thus improves battery life for the UE 20 without interruptions in the UE's connectivity. Of course there will be some interruption in the u-plane connectivity when the handover is directly between local cells that exhibit a coverage gap between them, but as noted above it is seen preferable to suffer this minor lapse in u-plane coverage rather than establish a new u-plane with the macro eNB 22 and all the control signaling that would entail. Besides, the description of FIG. 3 above details that by providing to the UE 20 in advance certain target-cell related information such as synchronization information and a dedicated RACH preamble, and also by performing path switching prior to the UE's u-plane re-attachment to the target AP 25, the disruption caused by the u-plane being disconnected can be mitigated quite effectively.

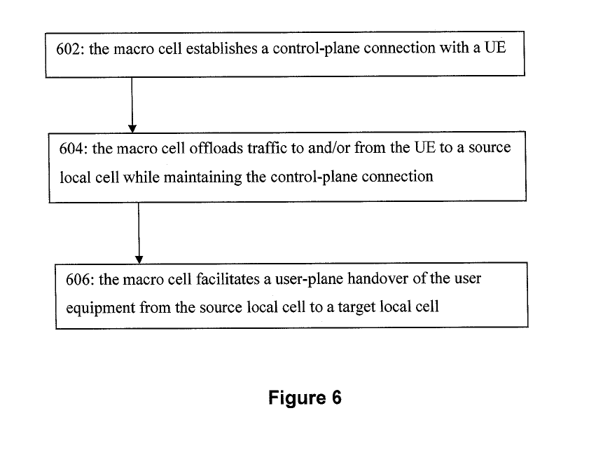

FIGS. 4-6 present logic flow diagrams from the perspective of the UE 20, the local source AP/cell 23, and the macro cell/eNB 22, respectively. These and the related expanded descriptions are intended to summarize the above examples and thus are not intended to be comprehensive for all the various options detailed above.

The logic flow diagram of FIG. 4 summarizes some of the various exemplary embodiments that are detailed above from the perspective of the UE 20. Specifically, block 402 provides the context in which the user equipment is connected to a macro cell at least in a control-plane during the remainder of FIG. 4. Then at block 404 the UE 20 establishes a user-plane connection to a source local cell. The UE predicts at block 406 when a user-plane handover from the source local cell will be needed; and at block 408 the UE utilizes the macro cell to facilitate the user-plane handover of the user equipment from the source local cell to a target local cell.

In one particular non-limiting embodiment, predicting when the user-plane handover from the source local cell will be needed comprises determining a coverage area of the source local cell; and utilizing location and mobility information of the user equipment with reference to the coverage area to predict when the user-plane handover from the source local cell will be needed.

In another non-limiting embodiment the coverage area of the source local cell is received by the user equipment from the source local cell either when the user equipment first establishes the user-plane connection with the source local cell or from broadcast system information.

In a further non-limiting embodiment the coverage area of the source local cell is received by the user equipment from the macro cell.

Another non-limiting embodiment finds that utilizing the macro cell to facilitate the user-plane handover comprises at least one of:
in response to sending to the macro cell information about the predicted user-plane handover, receiving from the macro cell information that identifies the target local cell;
receiving from the macro cell deployment map information which provides a location of at least the target local cell relative to the source local cell; and
receiving from the macro cell at least one of synchronization information about the target local cell and a dedicated preamble for establishing a u-plane connection with the target local cell.

In a further non-limiting embodiment the user equipment receives from the macro cell at least one of the synchronization information and the dedicated preamble, and the user-plane handover is characterized by a coverage gap between the source local cell and the target local cell during which the user-plane connection of the user equipment is dropped. In this case for this embodiment the user equipment utilizes the said at least one of the synchronization information and the dedicated preamble to re-attach the user-plane connection to the target local cell.

In a still further non-limiting embodiment the user equipment buffers uplink data while the user-plane connection of the user equipment is dropped, and sends the buffered uplink data to the target local cell once the user-plane connection of the user equipment is re-attached to the target local cell.

In the examples above, which also are non-limiting in this respect, the control plane connection to the macro cell is on licensed radio spectrum and the user-plane connection with the source local cell and with the target local cell is on license-exempt radio spectrum; and the user equipment utilizes E-UTRAN radio access technology for wirelessly communicating with the macro cell, the source local cell and the target local cell.

The logic flow diagram of FIG. 5 summarizes some of the various exemplary embodiments of the invention from the perspective of the source local cell 23. At block 502 the source local cell establishes with a user equipment a user-plane connection. Then at block 504 the source local cell provides to the user equipment information about a coverage area of the source local cell. Finally at block 506 the source local cell hands over the user-plane connection of the user equipment to a target local cell according to a handover prediction based on location and mobility of the user equipment.

In one particular non-limiting embodiment, the information about the coverage area of the source local cell is provided to the user equipment either in response to establishing the user-plane connection or in broadcast system information.

In another non-limiting embodiment the information about the coverage area includes, for all local cells in a same heterogeneous network as the source local cell and adjacent to the source local cell, location information relative to a location of the source local cell.

In a still further non-limiting embodiment the handover prediction is received from the user equipment by the source local cell.

In yet another non-limiting embodiment the handover prediction is done by the source local cell.

In another non-limiting embodiment, at least for the case in which the user-plane connection of the user equipment is dropped prior to handing over to the target local cell, the method further comprises sending a path switch request to a macro cell with which the user equipment has a control-plane connection; and providing context information of the user equipment to the target local cell.

The logic flow diagram of FIG. 6 summarizes some of the various exemplary embodiments of the invention from the perspective of the macro eNB 22. In this case at block 602 the macro cell establishes a control-plane connection with a user equipment. This is conventional and there may be a u-plane connection established with the c-plane at block 602. Then at block 604 the macro cell offloads traffic to and/or from the user equipment to a source local cell while maintaining the control-plane connection. Then at block 606 the macro cell facilitates a user-plane handover of the user equipment from the source local cell to a target local cell.

In various non-limiting embodiments, facilitating the user-plane handover comprises providing to the user equipment at least one of:
information that identifies the target local cell in response to receiving from the user equipment information predicting the user-plane handover;
deployment map information which provides a location of at least the target local cell relative to the source local cell; and
at least one of synchronization information about the target local cell and a dedicated preamble for establishing a u-plane connection with the target local cell.

The various blocks shown at FIGS. 4-6 may be considered as a plurality of coupled logic circuit elements constructed to carry out the associated function(s), or specific result of strings of computer program code or instructions stored in a computer readable memory. Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

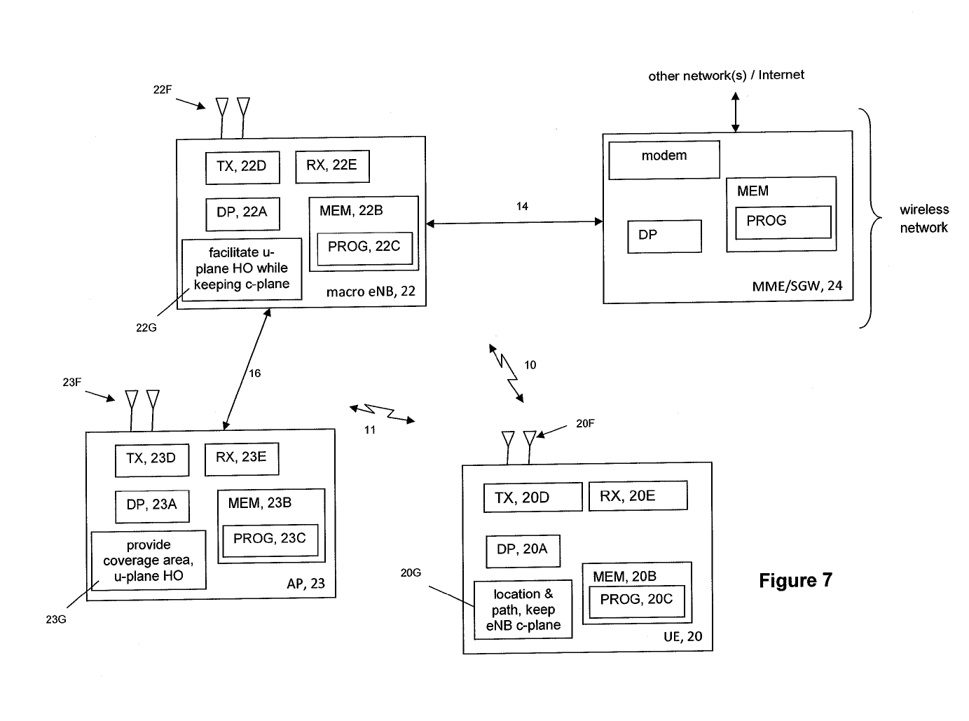

Reference is now made to FIG. 7 for illustrating a simplified block diagram of various electronic devices and apparatus that are suitable for use in practicing the exemplary embodiments of this invention. In FIG. 7 a macro eNB 22 is adapted for communication over a wireless link 10 with an apparatus, such as a mobile device/terminal such as a UE 20 and over a control/data link (such as an X2 link) with a local AP 23 which in this illustration is in the position of the source local AP. The UE 20 is in wireless communication with the source local AP 23 on the u-plane and with the macro eNB 22 22 on the c-plane. While in embodiments of these teachings there are typically several APs in cooperation with the macro eNB 22, and several UEs connected with the macro eNB 22 and possibly also with the source local AP 23, for simplicity only one source local AP 23 and one UE 20 is shown at FIG. 7. The macro eNB 22 may be any access node (including frequency selective repeaters or remote radio heads) other than a local AP of any cellular/licensed band wireless network such as LTE, LTE-A, GSM, GERAN, WCDMA, and the like. Similarly the source local AP 23 may be using any of those other exemplary radio access technologies on the unlicensed band, or it may be using non-cellular radio access technologies such as IEEE 802.11 for WLAN. The operator network of which the macro eNB 22 is a part may also include a network control element such as a mobility management entity MME and/or serving gateway SGW 26 or radio network controller RNC which provides connectivity with further networks (e.g., a publicly switched telephone network and/or a data communications network/Internet). The macro eNB 22 is coupled with the MME/SGW 26 via a control and data link 14.

The UE 20 includes processing means such as at least one data processor (DP) 20A, storing means such as at least one computer-readable memory (MEM) 20B storing at least one computer program (PROG) 20C or other set of executable instructions, communicating means such as at least one transmitter TX 20D and at least one receiver RX 20E for bidirectional wireless communications with the macro eNB 22 and the source local AP 23 via one or more antennas 20F. Also stored in the MEM 20B at reference number 20G is the UE's algorithm or function for measuring its location and mobility/path for either predicting itself when a handover (HO) is needed or sending its location and mobility information uplink to the macro eNB 22 or the source local AP 23 for prediction by either of those access nodes, while still keeping its c-plane connection with the macro eNB 22 as detailed further above.

The macro eNB 22 also includes processing means such as at least one data processor (DP) 22A, storing means such as at least one computer-readable memory (MEM) 22B storing at least one computer program (PROG) 22C or other set of executable instructions, and communicating means such as a transmitter TX 22D and a receiver RX 22E for bidirectional wireless communications with the UE 20 (or UEs) via one or more antennas 22F. The eNB's communication with the source local AP 23 is preferably over a wired or optical link 16 but in some case may be a wireless RF backhaul link. The macro eNB 22 stores at block 22G the algorithm or function for facilitating the u-plane handover of the UE 20 from the source local AP 23 to the target local AP (25 or 24 of FIG. 2) while still maintaining its c-plane connection with the UE 20.

Similarly, the source local AP 23 includes its own processing means such as at least one data processor (DP) 23A, storing means such as at least one computer-readable memory (MEM) 23B storing at least one computer program (PROG) 23C or other set of executable instructions, and communicating means such as a transmitter TX 23D and a receiver RX 23E for bidirectional wireless communications via wireless link 11 with the UE 20 (or UEs) via one or more antennas 23F and further communication means for exchanging information with the macro eNB 22. The source local AP 23 stores at block 23G the algorithm or function for providing to the UE 20 its geographic coverage area, and for handing over the u-plane connection of the UE 20 to a target local AP as is detailed above.

At least one of the PROGs 20C/20G/22C/22G/23C/23G in the UE 20, in the macro eNB 22 and in the source local AP 23 is assumed to include a set of program instructions that, when executed by the associated DP 20A/22A/23A, enable the device to operate in accordance with the exemplary embodiments of this invention, as detailed above. In these regards the exemplary embodiments of this invention may be implemented at least in part by computer software stored on the MEM 20B, 22B, 23B which is executable by the DP 20A of the UE 20 and/or by the DP 22A of the macro eNB 22 and/or by the DP 23A of the source local AP 23; or by hardware, or by a combination of tangibly stored software and hardware (and tangibly stored firmware). Electronic devices implementing these aspects of the invention need not be the entire devices as depicted at FIG. 7 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances. Exemplary but non-limiting embodiments of the macro eNB 22 and of the source local AP 23 were noted above as a base station, remote radio head, etc.

Various embodiments of the computer readable MEMs 20B, 22B, 23B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A, 23A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE and LTE-A system, as noted above the exemplary embodiments of this invention may be used with various other types of wireless radio access technologies.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1-40. (canceled)

41. A method comprising:
while a user equipment is connected to a macro cell at least in a control-plane:
establishing a user-plane connection to a source local cell;
predicting when a user-plane handover from the source local cell will be needed; and
utilizing the macro cell to facilitate the user-plane handover of the user equipment from the source local cell to a target local cell.

42. The method according to claim 41, in which predicting when the user-plane handover from the source local cell will be needed comprises:
determining a coverage area of the source local cell; and
utilizing location and mobility information of the user equipment with reference to the coverage area to predict when the user-plane handover from the source local cell will be needed.

43. The method according to claim 42, in which the coverage area of the source local cell is received by the user equipment from the source local cell either:
when the user equipment first establishes the user-plane connection with the source local cell; or
from broadcast system information.

44. The method according to claim 42, in which the coverage area of the source local cell is received by the user equipment from the macro cell.

45. The method according to claim 41, in which utilizing the macro cell to facilitate the user-plane handover comprises at least one of:
in response to sending to the macro cell information about the predicted user-plane handover, receiving from the macro cell information that identifies the target local cell;
receiving from the macro cell deployment map information which provides a location of at least the target local cell relative to the source local cell; and
receiving from the macro cell at least one of synchronization information about the target local cell and a dedicated preamble for establishing a u-plane connection with the target local cell.

46. The method according to claim 45, in which the user equipment receives from the macro cell the said at least one of the synchronization information and the dedicated preamble, in which the user-plane handover is characterized by a coverage gap between the source local cell and the target local cell during which the user-plane connection of the user equipment is dropped, the method further comprising:
the user equipment utilizing the said at least one of the synchronization information and the dedicated preamble to re-attach the user-plane connection to the target local cell.

47. The method according to claim 41, in which the control plane connection to the macro cell is on licensed radio spectrum and the user-plane connection with the source local cell and with the target local cell is on license-exempt radio spectrum.

48. An apparatus comprising
at least one processor; and
at least one memory including computer program code;
in which the at least one memory and the computer program code is configured, with the at least one processor, to cause the apparatus to at least:
while a user equipment comprising the apparatus is connected to a macro cell at least in a control-plane:
establish a user-plane connection to a source local cell;
predict when a user-plane handover from the source local cell will be needed; and
utilize the macro cell to facilitate the user-plane handover of the user equipment from the source local cell to a target local cell.

49. The apparatus according to claim 48, in which predicting when the user-plane handover from the source local cell will be needed comprises:
determining a coverage area of the source local cell; and
utilizing location and mobility information of the user equipment with reference to the coverage area to predict when the user-plane handover from the source local cell will be needed.

50. The apparatus according to claim 49, in which the coverage area of the source local cell is received by the user equipment from the source local cell either:
when the user equipment first establishes the user-plane connection with the source local cell; or
from broadcast system information.

51. The apparatus according to claim 49, in which the coverage area of the source local cell is received by the user equipment from the macro cell.

52. The apparatus according to claim 48, in which utilizing the macro cell to facilitate the user-plane handover comprises at least one of:
in response to sending to the macro cell information about the predicted user-plane handover, receiving from the macro cell information that identifies the target local cell;
receiving from the macro cell deployment map information which provides a location of at least the target local cell relative to the source local cell; and
receiving from the macro cell at least one of synchronization information about the target local cell and a dedicated preamble for establishing a u-plane connection with the target local cell.

53. The apparatus according to claim 52, in which the user equipment receives from the macro cell the said at least one of the synchronization information and the dedicated preamble, in which the user-plane handover is characterized by a coverage gap between the source local cell and the target local cell during which the user-plane connection of the user equipment is dropped;
and the at least one memory and the computer program code is configured with the at least one processor to cause the apparatus to further utilize the said at least one of the synchronization information and the dedicated preamble to re-attach the user-plane connection to the target local cell.

54. The apparatus according to claim 53, in which the at least one memory and the computer program code is configured with the at least one processor to cause the apparatus to further buffer uplink data while the user-plane connection of the user equipment is dropped, and send the buffered uplink data to the target local cell once the user-plane connection of the user equipment is re-attached to the target local cell.

55. An apparatus comprising
at least one processor; and
at least one memory including computer program code;
in which the at least one memory and the computer program code is configured, with the at least one processor, to cause the apparatus to at least:
establish with a user equipment a user-plane connection;
provide to the user equipment information about a coverage area of the source local cell; and
handover the user-plane connection of the user equipment to a target local cell according to a handover prediction based on location and mobility of the user equipment.

56. The apparatus according to claim 55, in which the information about the coverage area of the source local cell is provided to the user equipment either:
in response to establishing the user-plane connection; or
in broadcast system information.

57. The apparatus according to claim 55, in which the information about the coverage area includes, for all local cells in a same heterogeneous network as the source local cell and adjacent to the source local cell, location information relative to a location of the source local cell.

58. The apparatus according to claim 55, in which the handover prediction is received from the user equipment by the source local cell.

59. The apparatus according to claim 55, in which the handover prediction is done by the source local cell.

60. The apparatus according to claim 55, wherein at least for the case in which the user-plane connection of the user equipment is dropped prior to the handover to the target local cell, the at least one memory and the computer program code is configured with the at least one processor to cause the apparatus to further:
send a path switch request to a macro cell with which the user equipment has a control-plane connection; and
provide context information of the user equipment to the target local cell.
